(19) United States
(12) Patent Application Publication
(10) Pub. No.: US 2021/0317792 A1
(43) Pub. Date: Oct. 14, 2021

(54) VALVE FOR CONTROLLING EXHAUST GAS OR FRESH AIR IN A DRIVE UNIT OF A MOTOR VEHICLE OR GENERATOR

(71) Applicant: Vitesco Technologies GmbH, Hannover (DE)

(72) Inventors: Eusebio-Marius ALBERT, Schwalbach a. Ts. (DE); Razvan-George GAVRILA, Schwalbach a. Ts. (DE)

(21) Appl. No.: 17/271,708

(22) PCT Filed: Aug. 22, 2019
(86) PCT No.: PCT/EP2019/072443

§ 371 Date: Feb. 26, 2021

(30) Foreign Application Priority Data
Aug. 27, 2018 (EP) 18465563.7

(51) Int. Cl. F02D 9/10; F16K 27/02

(52) U.S. Cl. CPC F02D 9/106; F16K 1/224; F02D 9/1065; F16K 27/0218

(57) ABSTRACT

A valve for controlling exhaust gas or fresh air in a drive unit has an axial support structure arranged at the free end of a driveshaft for a valve body. The axial support structure has a securing ring arranged between a cover pressed into a valve housing and a bearing. The cover seals the valve housing and has an annular bead.

### CROSS REFERENCE TO RELATED APPLICATIONS

This is a U.S. national stage of Application No. PCT/EP2019/072443 filed Aug. 22, 2019. Priority is claimed on European Application No. EP 18465563.7 filed Aug. 27, 2018 the content of which is incorporated herein by reference.

### BACKGROUND OF THE INVENTION

### 1. Field of the Invention

The invention relates to a valve for controlling exhaust gas or fresh air in a drive unit of a motor vehicle or generator, having a valve housing that has a duct, a valve body, fastened to a driveshaft for opening or closing a flow cross section of the duct, a drive for pivoting the driveshaft, a bearing for the driveshaft in the valve housing, and an axial support structure for the driveshaft in the valve housing.

### 2. Description of Related Art

Such valves are used in particular in throttle flap connectors or exhaust gas flaps of modern motor vehicles and are known in practice. The valve body is screwed on the driveshaft and is pivoted together therewith. The driveshaft is guided out of the valve housing and into a further housing of the usually electrically configured drive. That end of the driveshaft that is remote from the drive has the bearing in the valve housing. The axial support structure ensures exact positioning of the throttle flap within the flow duct and at the same time the positioning of the driveshaft with respect to the drive.

In the case of the valve known in practice, a securing ring is arranged between the bearing and a shoulder in the valve housing, in a groove of the driveshaft. However, the groove causes a reduction in the cross-sectional area of the driveshaft between the bearing and valve body. As a result, the driveshaft requires a particularly large diameter for envisioned stability. A large diameter of the driveshaft results in high manufacturing costs of the valve and high inertia when the valve is adjusted.

### SUMMARY OF THE INVENTION

One aspect of the invention is based on the problem of developing a valve of the type mentioned at the beginning such that it has high stability and avoids large diameters of the driveshaft.

According to one aspect of the invention an axial support structure is arranged at a free end of the driveshaft as seen from a bearing.

As a result of this design, the axial support structure is arranged outside the mechanically loaded region of the driveshaft. In this way, the driveshaft is not weakened by the axial support structure and thus has high stability even in the case of a small diameter. Thus, the driveshaft can have a particularly small diameter. As a result of the small diameter, the driveshaft has particularly low inertia. As a result, it is also particularly easy to manufacture the driveshaft, because the latter can be produced with a constant diameter along the entire length as far as the support structure. Moreover, the valve can be produced particularly cost-effectively.

According to another advantageous development of the invention, the bearing of the driveshaft can be held in its position in an axially immovable manner when the bearing is arranged between the axial support structure and a shoulder of the valve housing.

According to another advantageous development of the invention, the axial support structure is designed in a particularly simple manner when the axial support structure has an edge of the driveshaft and a support, connected to the valve housing, for supporting the edge.

In order to further simplify the structural design of the valve, another advantageous development of the invention provides for the support to have a cover that seals the valve housing over the end of the driveshaft. Since it is necessary to seal the end of the driveshaft in any case, the number of components of the valve is kept low as a result.

According to another advantageous development of the invention, the valve can be manufactured particularly cost-effectively when the cover is manufactured from sheet metal and is pressed into the valve housing.

According to another advantageous development of the invention, the cover has particularly high stability when the cover manufactured from sheet metal has an annular bead as support.

The support could directly support the free end of the driveshaft. However, according to another advantageous development of the invention, the support structure is designed in a particularly uniform manner around the circumference of the driveshaft when the edge of the axial support structure protrudes from the driveshaft.

The protruding edge could be manufactured for example as a shoulder in one piece with the driveshaft. This results in particularly precise positioning of the driveshaft. However, as a result, it is costly to manufacture the driveshaft. To manufacture the valve particularly cost-effectively, another advantageous development of the invention provides for the driveshaft to have a groove and a securing ring that is inserted into the groove and forms the edge of the axial support. Such securing rings are known for example as shaft securing disks or C-shaped spring rings and are obtainable as commercial goods.

The driveshaft could have a flattened portion for supporting the valve body. However, this flattened portion causes a weakening of the cross section of the driveshaft such that the latter requires a large diameter.

According to another advantageous development of the invention, the driveshaft can be manufactured with a small diameter and yet has high stability when the driveshaft has an aperture, and when the valve body is in the form of a disk and is fastened in the aperture.

### BRIEF DESCRIPTION OF THE DRAWINGS

The invention permits numerous embodiments. To further illustrate its basic principle, one of these embodiments is illustrated in the drawing and will be described in the following text. In the drawing:

FIG. 1 is a schematic subregion of a motor vehicle having a drive motor and a valve;

FIG. 2 is an enlarged perspective exploded illustration of the valve from FIG. 1;

FIG. 3 is a sectional view through a subregion of the valve from FIG. 2 along the line and

FIG. 4 shows a detail IV of the valve from FIG. 3 on a greatly enlarged scale.

### DETAILED DESCRIPTION OF THE PRESENTLY PREFERRED EMBODIMENTS

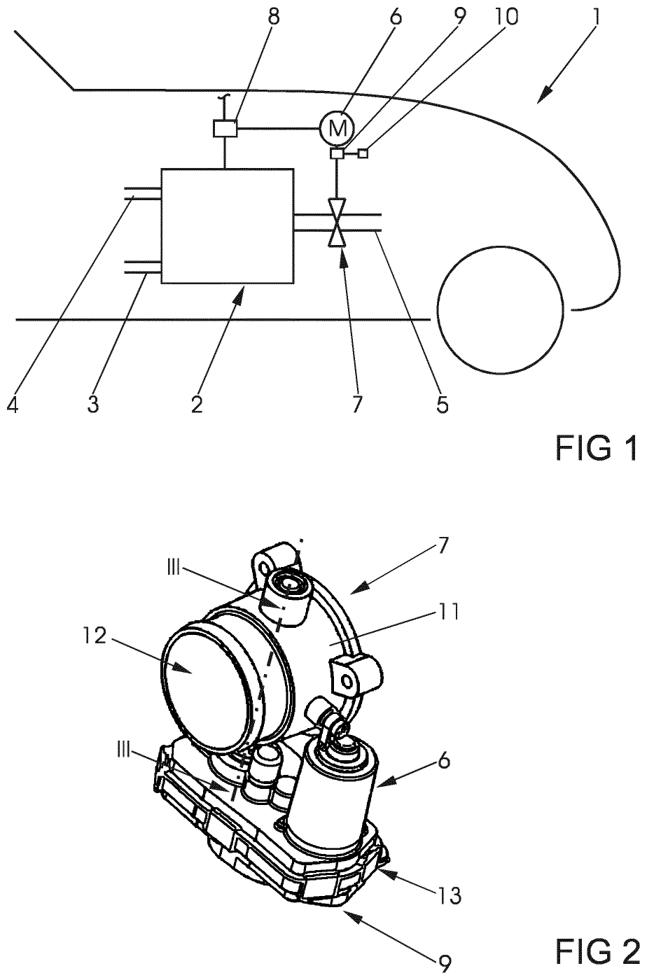

FIG. 1 schematically shows a subregion of a motor vehicle 1 having a drive unit that has a drive motor 2. The drive motor 2 can mechanically drive the motor vehicle or supply an electric drive (not illustrated) with electric current. The drive unit has two feed ducts 3, 4 for fuel, for example gaseous fuel and fresh air, and an exhaust line 5. The drive motor 2 can be, for example, a fuel cell or an internal combustion engine. Arranged in the exhaust line 5 is a valve 7 that is controllable by an electromotive drive 6.

In an embodiment that is not illustrated, the valve 7 can also be arranged in the feed duct 3, 4 conducting fresh air or conducting fuel.

Electric current generated by the drive motor 2 is supplied to a control device 8. The control device 8 is connected to an on-board electrical system (not illustrated) of the motor vehicle.

The electromotive drive 6 of the valve 7 is supplied with electric current via the control device 8. Arranged between the valve 7 and the electromotive drive 6 is a gear mechanism 9 having a position sensor 10. The position sensor 10 senses the position and thus the function of the valve 7.

FIG. 2 shows an enlarged perspective illustration of the valve 7 from FIG. 1. The valve 7 has a valve housing 11 having a duct 12. Fastened to the valve housing 11 is a drive housing 13 having the electromotive drive 6. The gear mechanism 9, schematically illustrated in FIG. 1, is likewise arranged in the drive housing 13.

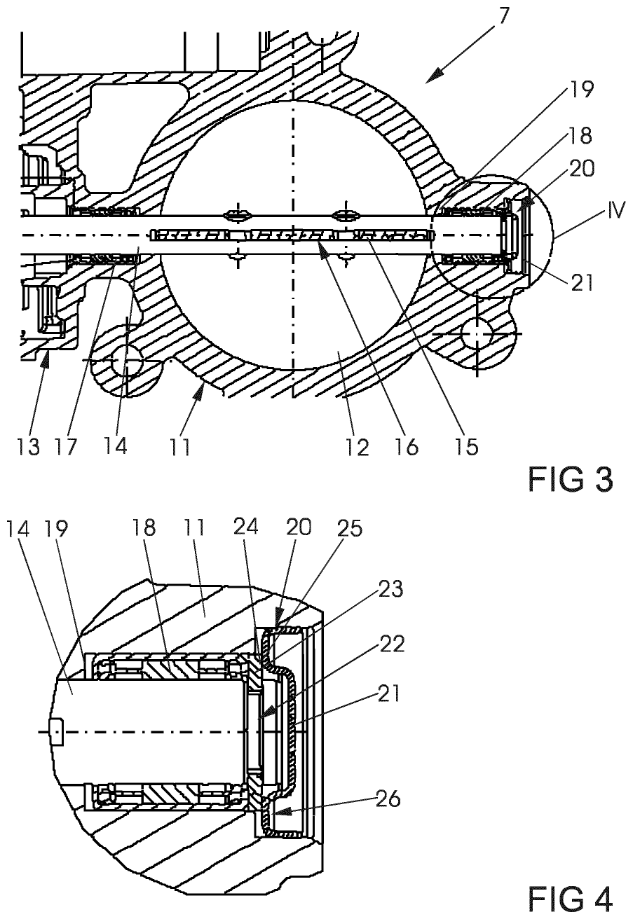

FIG. 3 shows a sectional illustration through the valve housing 11 from FIG. 2 with adjoining regions of the drive housing 13 along the line The valve 7 has a driveshaft 14, which is pivotable by the electromotive drive 6, having a disk-like valve body 15 arranged thereon. The valve body 15 is fastened in an aperture 16 in the driveshaft 14. As a result of the driveshaft 14 being pivoted, the flow cross section of the duct 12 is thus opened or entirely or partially closed. The driveshaft 14 has two bearings 17, 18. One of the bearings 18 is arranged close to the free end of the driveshaft 14 between a shoulder 19 in the valve housing 11 and an axial support structure 20. The valve housing 11 is closed by a cover 21 in the region of the free end of the driveshaft 14.

FIG. 4 shows, on a greatly enlarged scale, the detail IV from FIG. 3 with the bearing 18 arranged close to the free end of the driveshaft 14. The axial support structure 20 has a securing ring 23 arranged in a groove 22 of the driveshaft 14, and a support 24 arranged on the cover 21. The support 24 supports an outer edge 25 of the securing ring 23. In this way, the driveshaft 14 is axially supported and held in its position. The cover 21 additionally has an encircling bead 26 for reinforcing the support 24.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-9. (canceled)

10. A valve configured to control exhaust gas or fresh air in a drive unit of a motor vehicle or generator, comprising:
a driveshaft;
a valve housing that has a duct;
a valve body, fastened to the driveshaft, for opening or closing a flow cross section of the duct;
a drive configured to pivot the driveshaft; and
a bearing for the driveshaft arranged in the valve housing and having an axial support structure for the driveshaft in the valve housing;
wherein the axial support structure is arranged at a free end of the driveshaft as seen from the bearing.

11. The valve as claimed in claim 10, wherein the bearing is arranged between the axial support structure and a shoulder of the valve housing.

12. The valve as claimed in claim 10, wherein the axial support structure has an edge of the driveshaft and a support, connected to the valve housing, configured to support the edge.

13. The valve as claimed in claim 12, wherein the support has a cover configured to seal the valve housing over the free end of the driveshaft.

14. The valve as claimed in claim 13, wherein the cover is manufactured from sheet metal and is pressed into the valve housing.

15. The valve as claimed in claim 14, wherein the cover has an annular bead as the support.

16. The valve as claimed in claim 12, wherein the edge of the axial support structure protrudes from the driveshaft.

17. The valve as claimed in claim 12, wherein the driveshaft has a groove and a securing ring that is inserted into the groove that forms the edge of the support.

18. The valve as claimed in claim 10, wherein the driveshaft has an aperture, the valve body is a disk that is fastened in the aperture.
